(19) United States
(12) Patent Application Publication
(10) Pub. No.: US 2005/0028865 A1
(43) Pub. Date: Feb. 10, 2005

(54) Rapid access tire valve for a pneumatic tire on a rim of a vehicle and connector therefor

(76) Inventors: Ilya Nikolayev, Briarwood, NY (US); Nikolay Nikolayev, Briarwood, NY (US)

Correspondence Address: ILYA NIKOLAYEV, 139-27 PERSHING CRESCENT, BRIARWOOD, NY, 11435, US

(21) Appl. No.: 10/634,932

(22) Filed: Aug. 5, 2003

(51) Int. Cl. F16K 15/20

(52) U.S. Cl. 137/223

(57) ABSTRACT

A rapid access valve for a pneumatic tire on a rim comprises a tubular stem and a flexible base made of a rubber-like material. The bushing is bonded to the outer surface of the stem by an over-molding procedure. The stem has a flanged end with two cylindrical elements adjacent to it forwardly and rearwardly. The flanged stem and the connector are configured in respect to each other in such a manner so as to provide a releasable conduit through which a pressurized media can be delivered into a pneumatic tire or withdrawn from it. The connector assembly is equipped with a centrally located core depressor for engaging with a stop valve pin and for depressing it into the open position when the connector is attached onto the valve. The connector has a plurality of bearings, serving as detaining elements, for fast and reliable lockage of the connector onto the valve. The flanged end of the stem is configured to accept the displaceable bearings and to allow the bearings to fall behind the flange, formed on the outer periphery of the stems forward end, thus being locked between the outer surface of the stem and inner surface of the coaxially movable collar of the connector. Pulling the connector's collar coaxially and away from the valve releases the bearings from their locked deployment and allows the pressure blocking member of the stop-valve to return to its normally closed position.

### BACKGROUND OF THE INVENTION

1. Field of the Invention

The invention relates to valves and more specifically to a rapid access tire valve for a pneumatic tire on a rim of a vehicle and connector therefor to provide a leakage proof connection between the tire and the source of pressurized media in order to inflate or deflate automotive tires and the like in maintenance and repair situations.

2. Description of the Related Art

The majority of motor driven vehicles including automobiles, trucks, off-road vehicles, sport utility vehicles, all-terrain vehicles, motorcycles and the like ride on pneumatic tires made of a flexible, elastic, rubber-like material, which is sealingly mounted on a rigid rim. An air or gas mixture contained in the toroidal cavity formed between a tire and a rim is what provides the tire with its smooth ride on a highway or any other level road, its toughness through a desert or mud, and its ability to carry a weight load.

An essential and, by all means, the most critical element of any tire design is the tire stem with a valve core installed in it. The stem and the valve provide access into an otherwise sealed internal tire cavity and at the same time act to keep the air in the tire. Similarly, they serve as the only means of conveying air or other substances into the tire.

Thus, it is extremely important to have ready access to the stem valve during maintenance and for repair purposes, including tire inflation or deflation, and when a gas mixture or other media must be delivered into or evacuated from the tire.

The majority of tire valves are equipped with a tapped inlet nipple. Thus, there is a group of couplers that must be screwed onto the valve stem to form a passage for the air to be conveyed from the air source into the tire. An example of this kind of coupler is disclosed in U.S. Pat. No. 5,305,784. Because of the fine pitch of the stem thread and the mainly rigid connection between the coupler and the hose it is not an easy task to find the beginning of the thread. In addition, after every revolution, the hose becomes twisted and the user is forced to straighten it out in order to be able to proceed with the next revolution. Also, because the process of unscrewing the coupler off the stem is slow and the air passage thus becomes open before the valve stem returns to its closed position, there will always be a substantial amount of air lost after inflation thus making this method imprecise and unfriendly.

U.S. Pat. No. 3,926,205 teaches a tire chuck having a long gasket and a lever mechanism which, when moved, compresses the gasket and subsequently opens the tire stem valve. Although the device provides a fast means of making a coupling with a tire stem, it attempts to seal around a threaded surface, which was never proven to be a successful task. Another problematic outcome of this design is that the compression of the gasket necessary to properly seal is about 3 millimeters and the user must overcome the resistance of a 3-millimeter thick layer of rubber and the stiffness of the tire valve spring. Although these types of tire chucks are widely used on various types of tire inflating devices, they were found to be faulty in both the reliable opening of the stem valve and the providing of good sealing properties between the gasket and the surface of the stem thread. Poor control over the proper alignment of the chuck, which must be in place to open the stem valve, adds to the scope of the problems. The user must also perform two actions simultaneously—he must depress the lever while making sure to push the chuck in a direction that opposes the resistance placed on it by the tire stem. Only until the compression of the gasket is sufficient to expand it radially inward, thus providing grip between itself and the threaded surface of the tire stem, can the user finally lock the chuck into place.

U.S. Pat. No. 4,276,898 discloses a clip-on type of air chuck which is supposed to seal on the face surface of the stem and at the same time open the stem valve. This chuck uses a lever-type spring-loaded mechanism to lock itself in its operable position using the portion of the lever clenched between the two co-residing threads. These types of chucks use the fine-pitched thread of the stem and thus cannot provide enough holding force for forming a reliable passage for the air passing from the source of the pressurized media to the tire.

In all of the referenced materials, despite the obvious differences of the devices disclosed, all of them have common and known problems. None of them offer reliable sealing between the chuck and the tire valve. Most do not offer a means of providing proper alignment between the valve inlet nipple and the chuck. Also, they do not offer a reliable mechanism to open and release the stem valve without the loss of a substantial amount of fluid from the tire thus providing no control over sustaining an accurate pressure level inside the tire after inflation, which is extremely important for the safe operation of a vehicle. In addition, there is no locking mechanism provided which can be utilized to gain fast access into the inside cavity of the tire.

Although a tapped inlet has been widely used for an extensive period of time as the only existing means for the attachment of various types of connectors described above onto the tire valve, it is seen as a rudimental element of a tire system and is more of a way of paying tribute to the anachronistic tradition than a practical and trouble-free part of a contemporary mode of servicing pneumatic tires in the modern world.

There is a long-waited need in the field of art to give rapid access to the pressurized air or other gas or fluid substance in the tire so that anyone, from an ordinary motorist to a heroic soldier on the battlefield, can maintain the tire as needed—efficiently without suffering from the above mentioned drawbacks.

### SUMMARY OF THE INVENTION

Accordingly, it is an object of the invention to provide an average motorist with a rapid access tire valve for a pneumatic tire on a rim of a vehicle and connector therefor to allow quick and hassle free connecting or disconnecting of the source of the pressurized substance to be delivered into the tire for maintenance or repair purposes.

It is another object of the invention to provide a dependable operating system which, when used, will always form a continuous passage for the substance to flow into the tire or for the substance to be withdrawn from the tire.

It is another object of the invention to provide a simple and user-friendly functioning system through which connecting or disconnecting can be performed even by an unskilled operator.

It is another object of the invention to provide a reliable system, which can withstand high-pressure levels (up to 300 PSI) without abruptly disconnecting from the tire stem or the braking apart.

It is another object of the invention to provide an easily actuatable system through which there is little force needed for the rapid coupler to be connected or disconnected.

It is another object of the invention to provide a leak-free connection between the substance source and the tire valve.

It is another object of the invention to simplify the manufacturing process involved in the valve production by eliminating a thread cutting operation needed to produce a conventional valve stem.

It is another object of the invention to provide a much longer life cycle for the disclosed valve and the corresponding coupler through incomparably higher reliability of the joining elements as compared to the threaded valves and the chucks produced according to the patents mentioned in the description of the related art.

The above and other objects are fulfilled by the invention, which is a rapid access tire valve for a pneumatic tire on a rim of a vehicle and connector therefor and includes a valve, a rapidly acting coupler and a protective cap.

### BRIEF DESCRIPTION OF THE DRAWINGS

FIG. 1 is a partly sectional side view of a tire valve shows a longitudinal section of a tire valve mounted on a rim of a vehicle. The pressure stop valve is in its closed position.

FIG. 2 is a local view of the flanged end of the valve of FIG. 1 illustrating a variant of the preferred embodiment

FIG. 3 is a local view of the flanged end of the valve of FIG. 1 illustrating a variant of the preferred embodiment

FIG. 4 is a local view of the flanged end of the valve of FIG. 1 illustrating a variant of the preferred embodiment

FIG. 5 is a local view of the flanged end of the valve of FIG. 1 illustrating a variant of the preferred embodiment

FIG. 6 is a longitudinal section of a tire valve mounted on a rim of a vehicle and a connector coaxially aligned and locked, with the pressure stop valve in its open position.

FIG. 7 shows cross section taken on the line 7-7 of FIG. 6

FIG. 8 shows cross section taken on the line 8-8 of FIG. 6

FIG. 9 is a side view of the valve featuring another variant of the installation into the rim of a vehicle

FIG. 10 is a side view of another variant of the claimed valve, but for the tube of a tire, according to claim number 14

### DETAILED DESCRIPTION OF THE PREFERRED EMBODIMENTS AND DRAWINGS

Now, turning initially to FIG. 1, a preferred embodiment of the valve 101 of this invention comprises a tubular stem 301 having a flanged end 300, a pressure stop valve 302 of known type, having a spring loaded relief pin 303 and the base of the stem 304 for installation of the valve into aperture 305 of the tire rim 306.

The preferred tubular rigid valve stem 301 made generally of brass and the base 304, which is over molded all around it, with exemption of the flanged end 300 of the stem, is made of rubber or a rubber-like material having an adequate flexibility so as to provide one-step, snap-in installation into the tire rim aperture 305.

The preferred stem 301 has a valve chamber 307 having a screw thread on its inner surface at the bottom of the chamber as to provide secure and leak-free installation of the valve into it. The pressure stop valve 302 is closed under normal operating conditions. The flanged end 300 of the stem 301 comprises a first cylindrical element 311, a forward cone portion 312, flange element 310, rear cone portion 314 and, following it, cylindrical element 315.

The two other means for a valve attachment are illustrated by FIG. 9 and FIG. 10 The valve of FIG. 9 has a one-piece stem 200 having a threaded mounting end 201, and equipped with two nuts 202 and two seals 203 for secure and leak proof installation onto the tire rim 306.

The valve of FIG. 10 has a stem 301 as described below, but with the base 220 configured for vulcanization over a communication aperture of a conventional tube for a pneumatic tire.

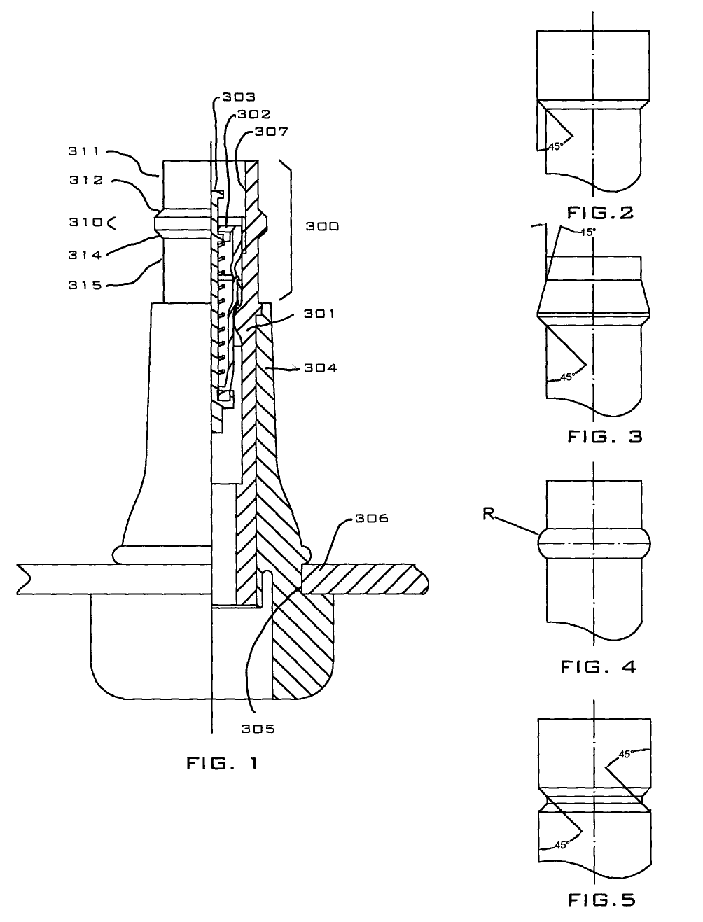

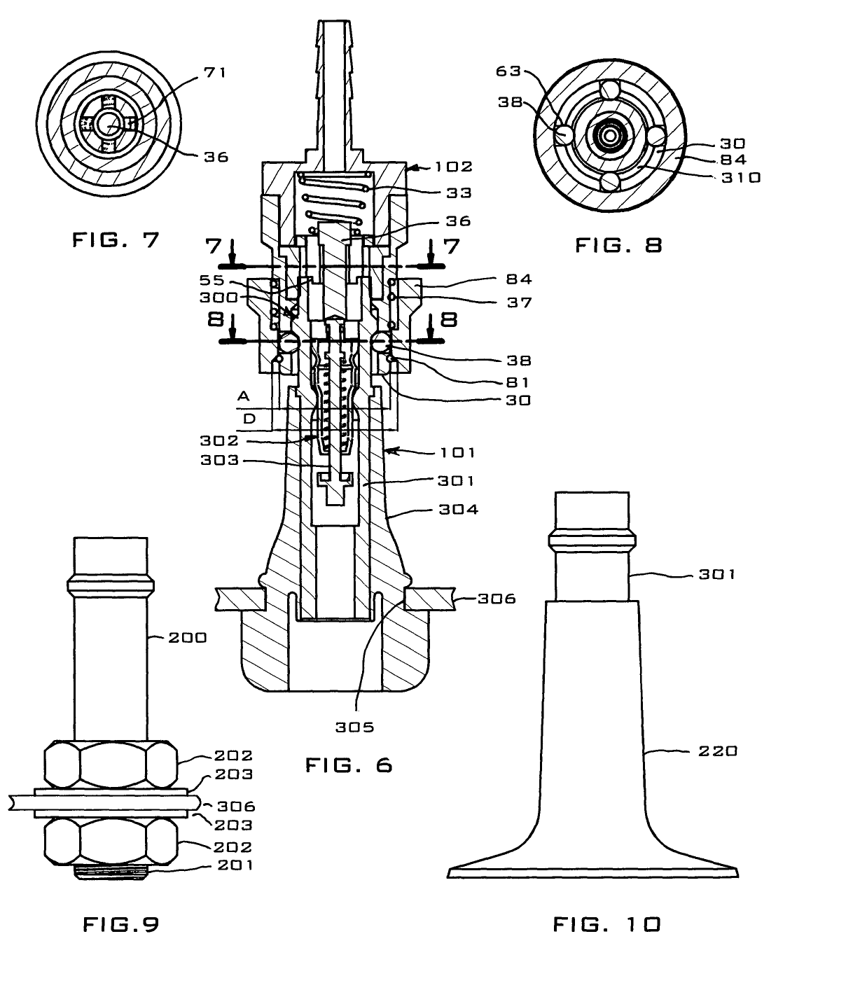

Referring now in detail to the drawing FIG. 6, an operation of the present invention is also illustrated by way of showing a connector indicated at 102 engaged onto the proposed tire valve 101. Upon engagement the relief pin 303 of the stop valve 302 is depressed to the open position by the depression pin 36 of the connector. The couplers depression pin 36 has a recess 55 to prevent the stop valve from being damaged due to travel beyond the maximum coupling depression location. Channels 71 in FIG. 7 are cut through the depression pin body to provide for unrestricted passage of fluid disregarding the otherwise potentially disruptive displacement of the depression pin during operation. The socket 30, of the coupler 102, is configured to receive the flanged end 300. The socket 30 has a circumferential row of spaced-apart orifices 63 in which the detents 38 are held as shown in the cross section in FIG. 8. The orifices are shaped as to restrict the radial inward location of the detents. More specifically, this location is restricted to be substantially equal to the diameter of the nose and rear portions of the flanged end 300. In the illustrated preferred embodiment, the detents 38, are in the form of spherically-shaped locking elements, which are adapted to releasably engage between the inner surfaces of the collar 84, and the flange element 310. The collar 84, which is coaxially reciprocatably movable along the socket body 30, restricts the outward radial displacement of the detents to be equal to one-half times of the difference between the diameters of the cylindrical surface of the collar at D and A. The collar 84, is normally biased forward to its locking position by the spring 37. The forward movement of the locking sleeve is limited by the retaining ring 81. With the flanged end 300 of the stem 304, and connector 102, coaxially aligned and engaged in the locked position as shown in FIG. 6, a passage for a pressurized medium is formed. The depression pin 36, which is normally biased forward by the spring 33, opens a stop valve 302. When the collar is in a retracted position, the detents are free to move radially outward and to unlock from behind the flange 310. The present graphic representation of the invention is exemplary and is by no means intended to limit the implementations of the invention to the one described. Therefore FIG. 2, FIG. 3, FIG. 4 and FIG. 5 show other possible solutions utilizing other designs of the flanged end of the proposed invention. FIG. 2 shows a flanged end with a 0-degree forward slope and a 45-degree rear slope while FIG. 3 shows a flanged end having a 15-degree forward slope and 45-degree rear slope of the cone portions adjacent to the flange element. FIG. 4 shows a flange element comprising spherical forward slope and rear slope. FIG. 5 illustrates a flanged end having a flange element with a 0-degree forward slope and a 45-degree rear slope and, following it, a raised cylindrical portion of the same diameter as the diameter of the flange element. Without further analysis and without going beyond and outside the scope of the present claims, it is understandable that others can, by applying current knowledge, adapt the concepts of these claims.

Nonetheless, they will not depart from the meaning and range of the present claims.

1. A rapid access tire valve for a pneumatic tire on a rim of a vehicle with said valve comprising:
a hollow stem having a stop-valve chamber located at close proximity to the coupling end of said stem;
a rubber base attached to the mounting end of said stem by means of an over-molding procedure, said base having means of mounting said valve on a rim of a vehicle;
a connector configured to be releasably engageable with said valve to provide an uninterruptible path for the conveyance of the pressurized media between the interior of a tire and the source of pressurized media;
a flange embodiment located at the coupling end of said stem to communicate with locking feature of said connector;
a first cylindrical embodiment adjoined to the front portion of said flange embodiment through a forward slope on the coupling end of said stem to create a sealing relation with sealing element of said connector;
a second cylindrical embodiment adjoined to the rear portion of said flange embodiment through a rear slope;
a force-operated pressure stop-valve sealingly installed into the valve chamber of said stem for blocking the passage of media through the bore of said stem in normal operating position; and
a protective cap to be pressed onto and over said coupling end so as to protect said stop valve and the surface of said flanged end during normal course of operation.

2. A valve as set forth in claim 1 wherein said valve chamber has internal screw thread for said stop-valve installation.

3. A valve as set forth in claim 1 wherein said flange embodiment is about 9 mm in diameter.

4. A valve as set forth in claim 1 wherein said first cylindrical embodiment is about 7 mm in diameter.

5. A valve as set forth in claim 1 wherein said second cylindrical embodiment is about 7 mm in diameter.

6. A valve as set forth in claim 1 wherein said first cylindrical embodiment is adjacent to said flange embodiment through a forward cone portion having a slope between 0 degrees and 45 degrees.

7. A valve as set forth in claim 1 wherein the said second cylindrical embodiment is adjacent to said flange embodiment through a rear cone portion having a slope between 45 degrees and 90 degrees.

8. A valve as set forth in claim 1 wherein said slopes are spherical.

9. A valve as set forth in claim 1 wherein said slopes and said flange embodiment are configured as an annular groove.

10. A valve as set forth in claim 1 wherein said forward slope is for the secure releasable engagement of the locking elements of said connector with said valve.

11. A valve as set forth in claim 1 wherein said rear slope is for the secure releasable engagement of the locking elements of said connector with said valve.

12. A valve as set forth in claim 1 wherein said pressure stop-valve is force-actuatable by making contact with the core depressor of said connector.

13. A valve as set forth in claim 1 wherein sealed joint between said valve and said connector is provided by the sealing element present in said connector.

14. A valve as set forth in claim 1 wherein a releasable joint between said connector and said valve is provided by deployment of at least one displaceable detent of said connector.

15. A valve as set forth in claim 1 wherein the position of said sealing element of said connector in relation to the length of said core depressor is so as to provide reliable seal between said valve and said connector prior to the opening of said stop valve.

16. A valve as set forth in claim 1 wherein said valve has a means of attaching it to the communication outlet aperture of the inner tube of a conventional pneumatic tire.

17. A valve as set forth in claim 1 wherein said rubber base is configured for snap-in installation of said valve into aperture of a wheel rim.

18. A stem of the valve as set forth in claim 1 wherein said stem has a threaded end to provide means of mounting said valve through an aperture of a wheel rim by locking nuts.
